(19) United States
(12) Patent Application Publication
(10) Pub. No.: US 2017/0291799 A1
(43) Pub. Date: Oct. 12, 2017

(54) SYSTEM FOR LIFTING PERSONS ONTO PLAYGROUND EQUIPMENT

(71) Applicant: PlayCore Wisconsin, Inc., Chattanooga, TN (US)

(72) Inventors: Thomas Norquist, Fort Payne, AL (US); Kim Blackwood, Boaz, AL (US); Edgar Montague, Charlotte, NC (US); Kurt Rampton, Charlotte, NC (US); William Riley, Charlotte, NC (US); Jereme Gilbert, Charlotte, NC (US)

(21) Appl. No.: 15/480,552

(22) Filed: Apr. 6, 2017

Related U.S. Application Data
(60) Provisional application No. 62/319,041, filed on Apr. 6, 2016.

(51) Int. Cl. B66B 9/00; A63G 31/00; B66B 13/00; B66B 11/04; B66B 13/04

(52) U.S. Cl. CPC B66B 9/00; B66B 11/0415; B66B 11/043; B66B 13/04; B66B 13/00; A63G 31/00

(57) ABSTRACT

The present disclosure is directed to a system for lifting one or more persons, such as a person having a mobility restriction, from a first level to a second level, such as onto a raised level of a play structure. In some embodiments, the system may also be configured so that an able-bodied person may enter and exit the platform even while the platform is being raised or lowered. In this way, the system may also comprise a play element by which able-bodied children are provided with a continuous play pathway. In some embodiments, the system is configured so that the platform rotates, thereby providing a fun experience that may be shared by persons having mobility restrictions and able-bodied persons.

This application claims priority to U.S. Provisional Application No. 62/319,041, filed on Apr. 6, 2016, the entirety of which is incorporated by reference herein.

### BACKGROUND OF THE INVENTION

Play structures, such as those found at playgrounds, typically involve at least one raised level on which children can play. In fact, the ability of children to reach a raised level of a play structure, to look out from a raised level of a play structure, and/or to explore a raised level of a play structure all provide a playground with an increased degree of play value. Though able-bodied children and adults may be able to access a raised level of a play structure through a variety of play elements, such as ladders, ropes, climbing nets and the like, there are few options for children and adults with disabilities or other mobility restrictions to access the raised level of a play structure. As a result, many play structures offer limited play value to children with disabilities or other mobility restrictions.

Conventionally, in order to provide access to a raised level of a play structure, a playground designer has been forced to incorporate a ramp or a series of ramps. Ramps of this sort, however, take up large amounts of valuable play space while adding little play value for able-bodied children. They are also quite expensive to build. In many areas, for example, regulations require that any such ramps require landings and turnarounds after every one foot of elevation change (minimum twelve foot expanse). As a result, due to limitations relating to space, budget, or both, the inclusion of ramps of this sort on play structures has been limited.

It is an object of at least one embodiment of the present disclosure to provide a new mechanism by which persons with mobility restrictions may reach the raised level of a play structure. It is believed that the mechanism disclosed herein may provide for a more efficient use of play space by taking up less space than a ramp while also providing a play opportunity, and thus an increased play value, for both able-bodied children and children with mobility restrictions. The mechanism disclosed herein may also provide increased opportunities for able-bodied persons and persons with mobility restrictions to share a social play experience.

### SUMMARY OF THE INVENTION

It is an object of at least one embodiment of the present disclosure to provide a system for lifting one or more persons, such as a person having mobility restrictions, from a first level to a second level, such as onto a raised level of a play structure. The system comprises a platform. The platform has at least a first access point and a second access point, through which both an able-bodied person and a person using a mobility device, such as a wheelchair, may enter and exit the platform. The system also comprises a first landing and a second landing, the first landing being adjacent to the first access point of the platform and the second landing being adjacent to the second access point of the platform. The first landing is positioned at a first level, for example at ground level or slightly above ground level, and the second landing is positioned at a second level, the second level being vertically displaced from the first level, i.e. at an elevated position relative to the first level. The system also comprises a lifting system that is configured to raise the platform vertically from the first level to the second level. In this way, a mobility-restricted person, such as a person in a wheelchair, can access the platform from the first landing and then be raised to the elevated second landing, which may for example be associated with a raised level of a play structure. The system is also configured to lower the platform vertically from the second level to the first level so that a mobility-restricted person can access the platform from the second landing and then be lowered back to the first, e.g. ground, level. In some embodiments, the system may be configured so that the platform rotates during the raising and/or lowering process, thereby providing a lifting system that includes a fun rotating motion.

In some embodiments, the system may be configured so that an able-bodied person may enter and exit the platform through either of the first and second access points while the platform is being raised or lowered or while the platform is stopped at any location between the first and second levels. For example, whether or not a mobility-restricted person is using the platform to access the raised level of a play structure, an able-bodied child may climb up to the second level by entering the platform through the first access point and exiting the platform through the second access point. Similarly whether or not a mobility-restricted person is using the platform to access the raised level of a play structure, an able-bodied child may climb down to the first level by entering the platform through the second access point and exiting the platform through the first access point. In this way, the system may also provide a play element comprising a continuous pathway across which able-bodied children may maintain an unimpeded flow of play.

It is an object of at least another embodiment of the present disclosure to provide a play structure comprising at least one lifting station that utilizes a system described herein. In some embodiments, the play structure may comprise at least a first lifting station and a second lifting station, with each utilizing an embodiment of the systems described herein. Each of the first and second lifting stations may, for example, be connected in series. In other words, the first (i.e. lower) level of a second lifting station may correspond with the second (i.e. upper) level of a first lifting station. In this way, the overall height of the raised level that may be reached may be increased. For example, where each lifting station is configured to raise a user 30 inches (2.5 feet), two lifting stations connected in series may be capable of raising a user 60 inches (5 feet).

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1A is a perspective view of an embodiment of the system, wherein the platform is at a lower level.

FIG. 1B is a perspective view of an embodiment of the system, wherein the platform is at an upper level.

FIG. 2 is a perspective view of an embodiment of the system, showing multiple lifting stations connected in series.

FIG. 3 is a plan view of an embodiment of the system, showing multiple lifting stations connected in series.

FIG. 4 is a side elevation view of an embodiment of the system, showing multiple lifting stations connected in series.

FIG. 5A is a side elevation view of an embodiment of the system, showing a construction by which a platform may be configured to spin during operation of the lifting system.

FIG. 5B is a side elevation view of an alternative embodiment of the system, showing a construction by which a platform may be configured to spin during operation of the lifting system.

FIG. 5C is a side elevation view of an alternative embodiment of the system, showing a construction by which a platform may be configured to spin during operation of the lifting system.

### DETAILED DESCRIPTION OF THE INVENTION

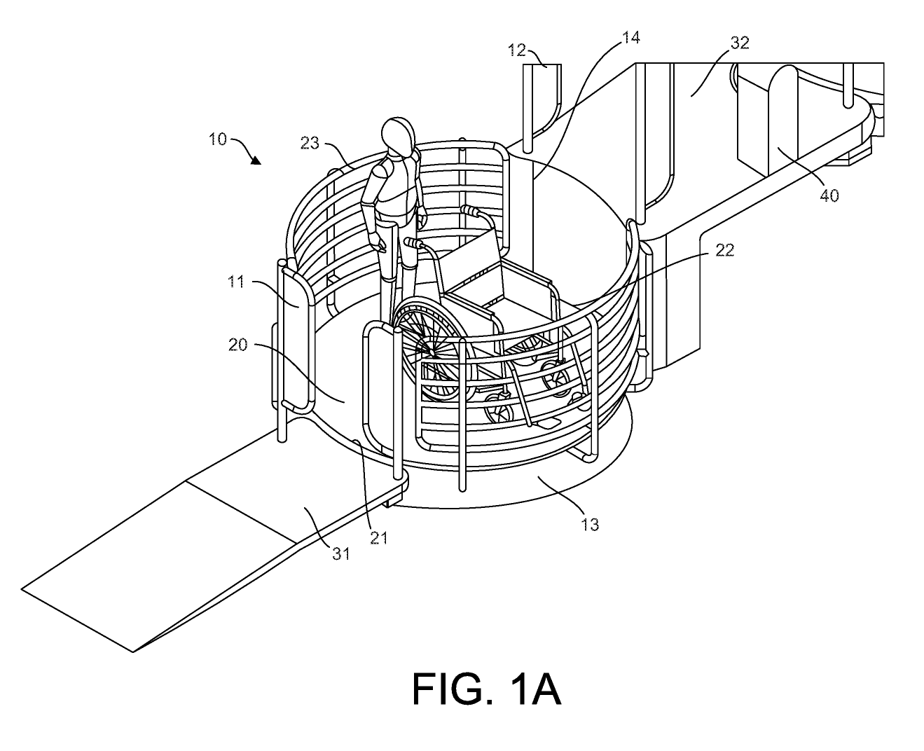

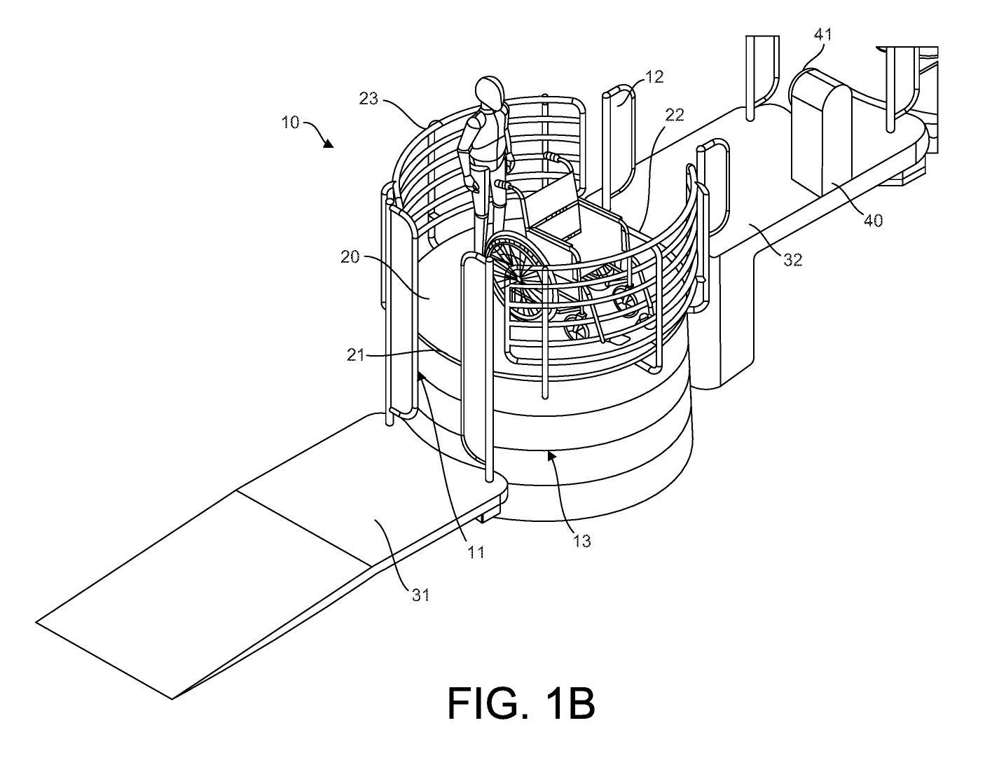

An embodiment of the system 10 of the present disclosure is illustrated in FIGS. 1A and 1B. The system comprises a platform 20 that is movable between a first, lower level, as shown in FIG. 1A and a second, higher level, as shown in FIG. 1B. The platform 20 may be configured to easily accommodate at least one wheelchair. In some embodiments, such as those illustrated in FIG. 1, the platform may be circular. For example, in some embodiments, the platform 20 may be circular and have a diameter between about 65 and about 80 inches. For example, in some embodiments, the platform 20 may be circular and have a diameter of about 72 inches (6 feet). In other, non-illustrated embodiments, the platform 20 may take other shapes. For example, the platform 20 may be rectangular, square, oval-shaped, polygonal, etc. In some embodiments, the shape of the platform 20 may be selected to coincide with a particular theme, such as where the system 10 is used in association with a themed play structure.

The platform 20 has at least a first access point 21 and a second access point 22. Each access point is configured so that a user may enter or exit the platform. For example, each of the access points 21, 22 is desirably configured to provide sufficient clearance for a wheelchair to pass through. In some embodiments, such as that illustrated in the Figures, the first and second access points 21, 22 may be on opposing sides or quadrants of the platform 20, e.g. at an angle of about 180 degrees from one another. In other, non-illustrated embodiments, the first and second access points 21, 22 may be located at different positions around the perimeter of the platform. For example, in some embodiments, the first and second access points 21, 22, may be located on adjacent sides or quadrants of the platform 20, e.g. at an angle of about 90 degrees from one another.

In some embodiments, the platform may comprise additional access points, such as an optional third access point and an optional fourth access point, such that a person could choose to enter the platform from a number of directions and/or exit the platform in a number of directions. For example, when in a raised position, the platform 20 may be associated with multiple landings, i.e. landings on more than one side. This may occur where the platform 20 is associated with a corner of a raised play level or with the intersection of multiple pathways in a raised play level. In these embodiments, a user may select which path to take upon exiting the platform 20, which is believed to provide additional play value.

In some embodiments, the platform 20 may comprise safety rails 23 around its perimeter. The safety rails are configured to prevent any person from entering or exiting the platform 20 except through the intended access points. Desirably, the safety rails 23 still allow for one to see onto and off of the platform 20.

The system 10 also comprises one or more landings 30. For example, the system may comprise at least a first landing 31 and a second landing 32. The first landing 31 is positioned at the first, or lower, level to which the platform may be moved, such as is illustrated in FIG. 1A. The second landing 32 is positioned at the second, or higher, level to which the platform may be moved, such as is illustrated in FIG. 1B. Moreover, the first landing 31 is adjacent to the first access point 21 of the platform while the second landing 32 is adjacent to the second access point 22 of the platform. Accordingly, when the platform 20 is moved into its lowered position, the first access point 21 is aligned with the first landing 31 and when the platform 20 is moved into its raised position, the second access point 22 is aligned with the second landing 32. In this way, a mobility-restricted person, such as a person on a wheelchair, may travel between the first landing 31 and the platform 20 (when the platform is in the lowered position) or between the platform and the second landing 32 (when the platform is in the raised position). Desirably, the platform 20 is substantially level with the first landing 31 when in the lowered position and the platform is substantially level with the second landing 32 when in the raised position so that a mobility-restricted person may easily travel between the platform and the respective landing.

In some embodiments, such as that illustrated in FIG. 1, the first landing 31 may be located at ground level or slightly above ground level. In other embodiments, such as where multiple lifting stations may be connected in series, the first landing 31 may be raised a desired height above ground level. The second landing 32 is vertically displaced, i.e. elevated, relative to the first landing 31. In some embodiments, the system 10 may comprise additional landings 30, such as an optional third landing and an optional fourth landing. Each of the additional landings 30 may be associated with either the first level or the second level. Each of the additional landings 30 may also be associated with additional, i.e. optional third and fourth, platform access points. For example, in the above-described embodiment where the platform 20 is associated with a corner of a raised play level or with the intersection of multiple pathways in a raised play level, the raised play level may have more than one landing by which a person may choose to enter and/or exit the platform 20.

The system 10 also comprises a lifting system 40 that is configured to raise the platform 20 vertically from a first level to a second level and lower the platform vertically from the second level to the first level. In some embodiments, the lifting system 40 may comprise a chain hoist 42, such as are generally known and understood in the art. A chain hoist 42 utilizes a system in which a low force, long distance input to a drive chain is converted to a high force output over a short distance on a load-bearing chain. Thus, one may raise the platform 20 by pulling the drive chain in one direction and lower the platform by pulling the drive chain in another direction.

In some embodiments, the chain hoist 42 may be manually controlled. In this manner, the lifting system 40 may utilize the manual energy input by one or more children and/or adults to provide the power necessary to raise and lower the platform 20. For example, in some embodiments, the chain hoist 42 may be operatively connected to one or more hand cranks 41. Each hand crank 41 may comprise, for example, a wheel that is operatively connected to the drive chain so that turning the wheel in a particular direction results in a directional force on the drive chain and thus to a raising or lowering of the platform 20.

In some embodiments, at least one of the hand cranks 41 may be located at the platform 20, such that an occupant of the platform may control the raising and lowering action him or herself. In some embodiments, at least one of the hand cranks 41 may be located at one of the first landing 31 and the second landing 32. In this way, an able-bodied person may operate the hand crank 41 without being on the platform 20. In some embodiments, a first hand crank 41 may be located at the first landing 31 and a second hand crank may be located at the second landing 32 to provide that multiple able-bodied persons may work together to raise or lower the platform 20. The action of controlling the raising and lowering of the platform 20 provides able-bodied children with a play opportunity, and particularly with a play opportunity that is socially inclusive of disabled or other mobility-restricted persons.

In other embodiments, the lifting system 40 may comprise an automatic lift or motorized hoist. In these embodiments, the action of raising and lowering the platform 20 may be controlled simply by pushing a button on one or more controllers. The one or more controllers may be located on the platform 20, on the one or more landings 31, 32, or a combination of the above. In some embodiments, the motorized lifting system may take advantage of solar power opportunities. For example, in some embodiments, the platform 20 may comprise solar panels (e.g. on the floor of the platform) that are configured to collect energy that may be transferred to the lifting system 40 for operation.

In some embodiments, the system 10 may also comprise one or more safety gates. In some embodiments, for example, the system may comprise at least a first safety gate 11 and a second safety gate 12. The first safety gate 11 may be configured to prevent a wheelchair from accessing or exiting the platform 20 through the first access point 21 unless the platform is at the first level. Because of the first safety gate 11, for example, a wheelchair that is located on the platform 20 may not inadvertently fall onto the first landing 31 until the platform is properly aligned with the first landing. The second safety gate 12 may be configured to prevent a wheelchair from accessing or exiting the platform 20 through the second access point 22 unless the platform is at the second level. Because of the second safety gate 12, for example, a wheelchair that is located on the second landing 32 may not inadvertently fall onto the platform 20 until the platform is properly aligned with the second landing. The first safety gate 11 may also prevent a mobility-restricted person from attempting to access the platform 20 from the first landing 31 or from attempting to exit the platform onto the second landing 32 while the platform is being raised or lowered.

For example, in FIG. 1A, the platform 20 is shown as being located at the first level. Accordingly, the first safety gate 11 is in an opened position, allowing for user of a mobility device, such as a wheelchair, to freely travel between the first landing 31 and the platform 20 [NOTE—the present drawing incorrectly shows the first safety gate in a closed position rather than an open position]. The second safety gate 12, on the other hand, is in a closed position, preventing a user of a mobility device, such as a wheelchair, to travel between the second landing 32 and the platform 20 [NOTE—the present drawing incorrectly shows the second safety gate in an open position rather than a closed position]. In FIG. 1B, the platform 20 is shown as being located at the second level. Accordingly, the second safety gate 12 is in an opened position, allowing for user of a mobility device, such as a wheelchair, to freely travel between the second landing 32 and the platform 20. The first safety gate 11, on the other hand, is in a closed position, preventing a user of a mobility device, such as a wheelchair, to travel between the first landing 31 and the platform 20.

In some embodiments, such as those illustrated in the Figures, each safety gate may comprise swinging doors. The swinging doors may, for example, include a first swinging door on one side of the access point with which the safety gate is associated and a second swinging door on the opposite side of the access point with which the safety gate is associated. The swinging doors may move together between a closed position, in which they are positioned across the access point in order to block off all or part of the access point, and an open position, in which they face away from the platform 20 so as not to restrict the access point.

In some embodiments, each of the safety gates may be configured so that the raising and lowering of the platform 20 actuates the opening and closing of the safety gates at the appropriate times. For example, the first safety gate 11 may be operably connected to the lifting system 40 so that, as the platform 20 is raised away from the first level, the first safety gate is actuated from an open position to a closed position. Similarly, the first safety gate 11 may be operably connected to the lifting system 40 so that, as the platform 20 is lowered toward the first level, the first safety gate is actuated from a closed position to an open position. The second safety gate 12 may be operably connected to the lifting system 40 so that, as the platform 20 is lowered away from the second level, the second safety gate is actuated from an open position to a closed position. Similarly, the second safety gate 12 may be operably connected to the lifting system 40 so that, as the platform 20 is raised toward the second level, the second safety gate is actuated from a closed position to an open position.

In some embodiments, the safety gate may be configured to that in the closed position, the access point with which the safety gate is associated remains partially unrestricted so that an able-bodied child may still access and exit the platform 20 through the access point. For example, when the safety gate is closed, the swinging doors may be configured so that there remains a space between the first and second swinging doors. This space may be sized and configured to allow an able-bodied child to pass in between the first and second swinging doors. This allows for able-bodied children to travel freely between the first landing 31 and the platform 20 and the second landing 32 and the platform 20 at all time, e.g. even when the platform is being raised or lowered. In FIG. 1B, for example, even though the platform 20 is at the second level and aligned with the second landing 32, an able-bodied child may step and/or climb from the first landing 31 onto the platform through the space that remains between the closed doors of the first safety gate 11. Similarly, an able-bodied child may step and/or climb from the platform 20 to the first landing 31 through the space that remains between the closed doors of the first safety gate 11. In this way, an able-bodied child may be provided with a continuous play pathway during all stages of system 10 operation. At the same time, however, a mobility device, such as a wheelchair, would be incapable of fitting through the space that remains between the closed doors of the first safety gate 11, and thus could not fall from the platform 20 onto the first landing 31.

In those embodiments in which there are additional platform access points and additional landings, as described in more detail above, the system 10 may also comprise additional safety gates (e.g. an optional third safety gate and an optional fourth safety gate). The additional safety gates may be configured to serve the same function as the first or second safety gates 11, 12 described herein.

The system 10 may also comprise a protective shield 13 positioned below the platform 20 and configured to prevent persons and objects from entering the space below the platform. The protective shield 13 desirably spans from the platform 20 all the way to the ground. The protective shield 13 may take on a variety of configurations. In some embodiments, such as those illustrated in the Figures, the protective shield 13 may comprise a series of telescoping units. For example, each unit (or section) of the protective shield may be slightly smaller than the unit below it so that the protective shield 13 may collapse downward as the platform 20 is lowered and expand upward as the platform 20 is raised. In other embodiments, the protective shield 13 may comprise a flexible material that is designed to fold in upon itself in order to collapse during lowering of the platform 20.

The system 10 may also comprise one or more protective covers 14 positioned between the edge of each of the landings and the platform. Each protective cover is configured to prevent persons and objects on the platform 20 and/or each landing from being pinched between the platform and the landing. For example, the system may comprise at least a first protective cover positioned between the edge of the first landing 31 and the platform 20 and configured to prevent persons and objects from being pinched between the platform and the first landing, and a second protective cover positioned between the edge of the second landing 32 and the platform 20 and configured to prevent persons and objects from being pinched between the platform and the second landing. In some embodiments, the protective covers 14 may each be made of high density polyethylene (HDPE) and positioned in a channel to ensure that it is held in place.

As described above, the system 10 may be configured to provide a continuous play pathway for able-bodied children. Regardless of the position of the platform (e.g. raised, lowered, or in motion), the system 10 may be configured to allow able-bodied children to enter and exit the platform 20 through any of the access points. In some embodiments, for example, the system 10 may be configured so that an able-bodied person may both (i) enter the platform 20 through the first access point 21 and exit the platform through the second access point 22 and (ii) enter the platform through the second access 22 point and exit the platform through the first access point 21 while the platform is being raised or lowered. In some embodiments, for example, the platform 20 may be configured to accommodate a wheelchair while also providing at least one accessible path between the first and second access points 21, 22. In those embodiments where the platform 20 contains additional access points, the platform may be configured to accommodate a wheelchair while also providing at least one accessible path between each of the access points.

In order to configure a system to provide a continuous play pathway for able-bodied children, the distance travelled by the platform 20 between the first and second levels should be limited. In some embodiments, therefore, the distance between the first and second levels is less than 48 inches (4 feet), alternatively less than 42 inches (3.5 feet), alternatively less than 36 inches (3 feet). In some embodiments, for example, the second level is between about 24 inches (2 feet) and about 36 inches (3 feet) above the first level. More particularly, in some embodiments, the second level is about 30 inches (2.5 feet) above the first level. Accordingly, embodiments of the system 10 may each alone be inadequate to reach a desirable height, such as the height of a raised play surface.

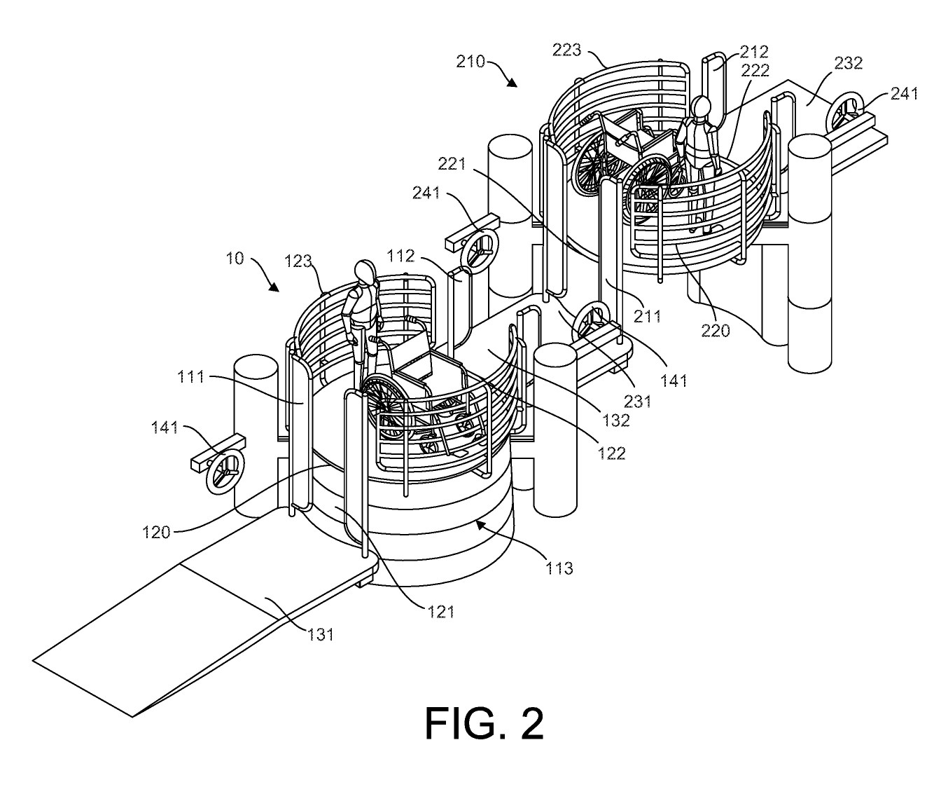

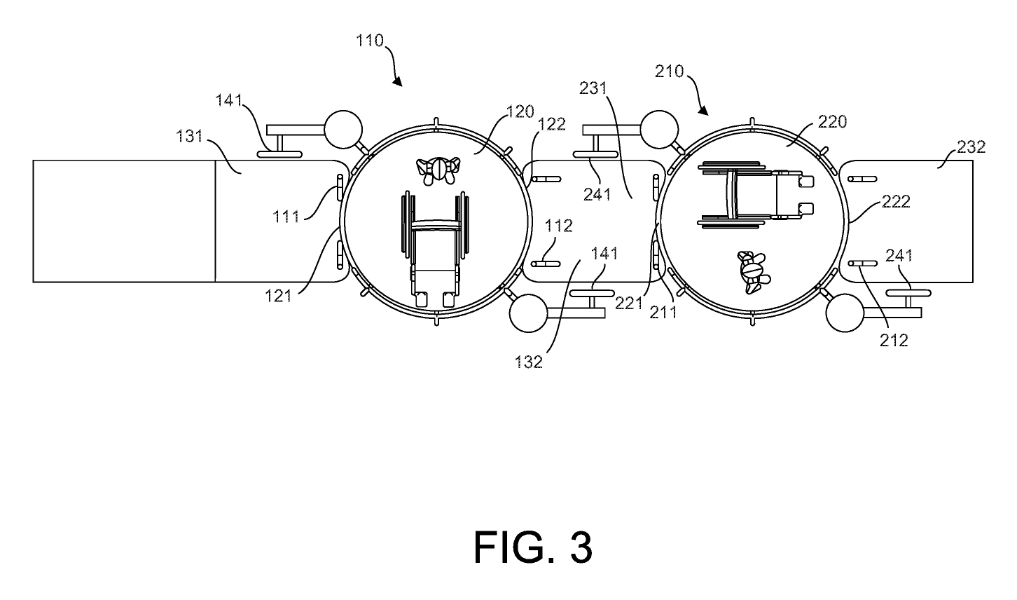

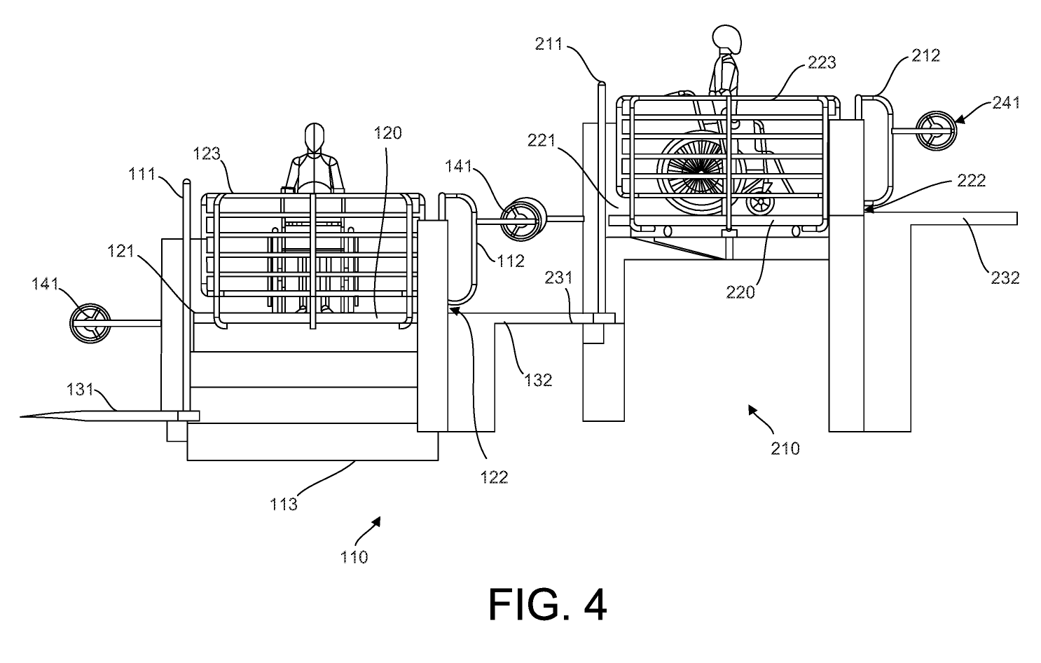

Accordingly, embodiments of the present disclosure are also directed to a structure, such as a play structure having a raised play level, comprising a plurality of lifting stations, with at least one of the lifting stations utilizing an embodiment of the system 10 disclosed herein. As illustrated in FIGS. 2-4, for example, the structure may comprise, at least a first lifting station 110 and a second lifting station 210, each of which utilizes an embodiment of the system 10 disclosed herein. The plurality of lifting stations may be connected in series so that an increased height may be reached. For example, where each of the first and second lifting stations 110, 210 are connected in series, as shown in the illustrated embodiment, the height of the structure that may be reached using the combination of lifting stations may be doubled. Assuming, for instance, that each lifting station 110, 210 comprises a system 10 that is configured to reach a second level that is about 30 inches (2.5 feet) above the first level, the combination of the lifting stations may be used to reach a structure having a height of about 60 inches (5 feet).

In some embodiments in which a plurality of lifting stations are connected in series, the second landing 32 of one or more of the lifting stations may also serve as the first landing 31 of a subsequent lifting station. For example, in the embodiment illustrated in FIGS. 2-4, the second landing 132 of the first lifting station 110 also serves as the first landing 231 of the second lifting station 210. Should an additional, i.e. third, lifting station be connected in series, the second landing 232 of the second lifting station 210 may similarly serve as the first landing of the third lifting station. This may provide the additional benefit of limiting the footprint of the lifting portion of the structure. In other (non-illustrated) embodiments, additional floor elements may be included between each of the lifting stations. For example, there may be a number of floor components separating the second landing 132 of the first lifting station 110 and the first landing 231 of the second lifting station 210.

Additionally, while the embodiments shown in FIGS. 2-4 only contain a single, linear pathway by which one may reach the raised structure, other embodiments containing multiple and/or non-linear pathways to reach a raised structure are also contemplated herein.

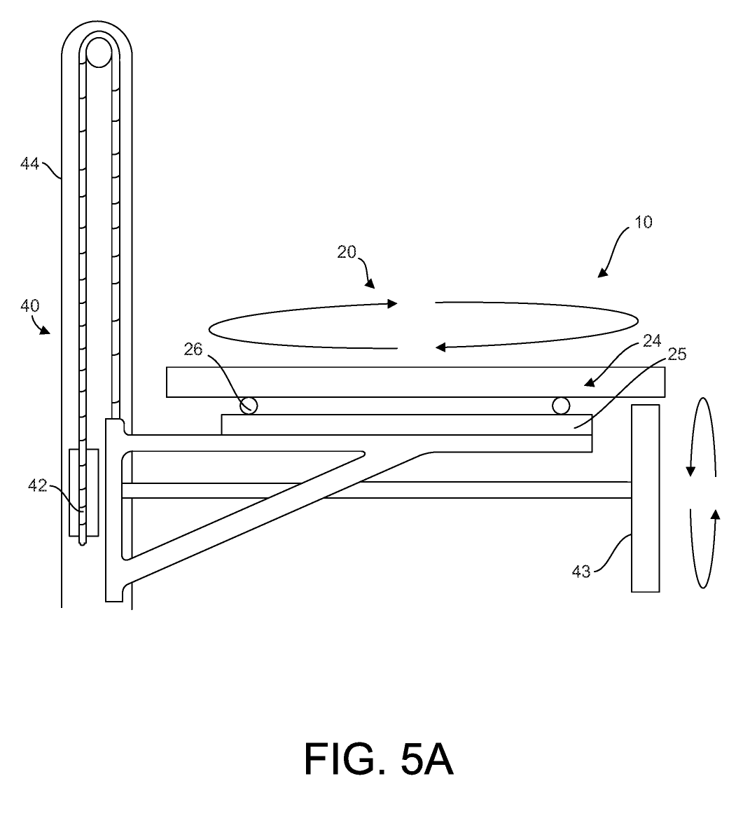

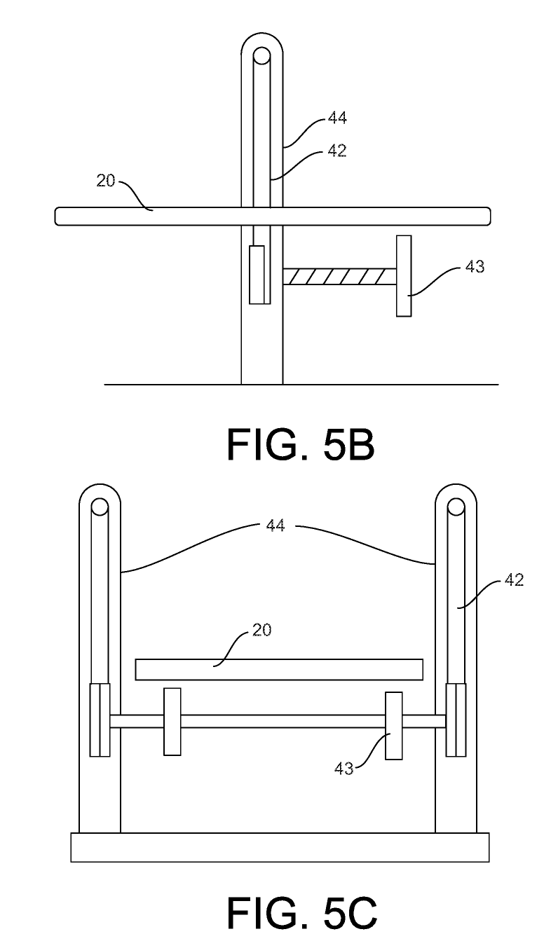

In some embodiments, the platform 20 may be configured to rotate. In this way, the system 10 may provide a fun rotating motion that may be enjoyed by all users, including both able-bodied children and users of mobility devices. For example, in some embodiments, the platform 20 may comprise a rotating floor 24. An embodiment of a platform 20 having a rotating floor 24 is illustrated in FIG. 5. As illustrated, for instance, the rotating platform floor 24 may be rotatably connected to a platform base 25, such as through one or more bearings or rollers 26. In this way, the platform 20 may provide both a rotating floor component 24 and a stationary base component 25 that supports the rotating floor and which may be associated with the lifting system 40 that is used to raise and lower the platform 20.

The rotation of the platform 20 may be operably connected with the lifting system 40 so that the spinning motion coincides with the raising and/or lowering of the platform. By this, it is meant that (a) the raising or lowering of the platform causes the platform to rotate, (b) the rotation of the platform causes the raising or lowering of the platform, or (c) the combination of (a) and (b).

For example, in some embodiments, the operation of the lifting system 40 to raise or lower the platform 20 may cause the platform floor 24 to rotate. One such embodiment is illustrated in FIG. 5. The lifting system 40 illustrated in FIG. 5 comprises a chain hoist 42 that is configured to raise or lower the platform 20, as previously described. The chain hoist 42 in the embodiment of FIG. 5, however, is associated with one or more wheels 43 such that operation of the chain hoist to raise or lower the platform also causes the one or more wheels 43 to spin. The one or more wheels 43 are operably connected to the underside of the platform floor 24 so that the spinning motion of the one or more wheels is translated to the platform floor 24, causing the platform floor to rotate. In this embodiment, for example, a user may operate one of the one or more hand cranks 41 in order to cause the platform 20 to rotate as it is being raised or lowered. Once the platform has reached a desired landing 31, 32, the rotation will cease and a user of a mobility device may easily enter or exit the platform. While FIG. 5 illustrates an embodiment employing a chain hoist 42, a similar platform rotation system could also be incorporated into an automatic lift or motorized hoist. In other (non-illustrated) embodiments, the platform 20 may comprise one or more screws that operate to cause rotation of the platform as a component of the raising and lowering motion.

In some embodiments, the platform 20 may be configured so that a user may manually spin the platform 20. For instance, the platform 20 may be configured so that an able-bodied person may stand on the platform, hold onto the safety rail 23, and cause the platform floor 24 to rotate using his or her legs. In some embodiments, the manual rotation of the platform 20 by a user may be independent from the raising and/or lowering of the platform. In other embodiments, however, the platform 20 may be configured so that the manual rotation of the platform 20 by a user causes the platform to travel between the first and second levels.

In the embodiment illustrated in FIG. 5, for instance, the user-produced rotating motion of the platform floor 24 may be transferred to the one or more wheels 43. The one or more wheels 43 may be operatively connected to the chain hoist 42 so as to operate the chain hoist and cause the platform to raise or lower. Whether the platform is raised or lowered will depend on the direction of the rotation. For instance, a user may rotate the platform in a first direction in order to cause the platform to be raised and a user may rotate the platform in a second direction in order to cause the platform to be lowered. The rotation-controlled raising and lowering of the platform may take the place of the raising and lowering of the platform by the one or more hand cranks 41, or the two may operate in conjunction with one another. Additionally, while FIG. 5 illustrates an embodiment employing a chain hoist 42, a similar platform rotation system could also be incorporated into an automatic lift or motorized hoist.

Although FIG. 5 is described as demonstrating a system in which both (a) the raising or lowering of the platform causes the platform to rotate and (b) the rotation of the platform causes the raising or lowering of the platform, the system shown in FIG. 5 could also easily be configured so that only (a) the raising or lowering of the platform causes the platform to rotate or so that only (b) the rotation of the platform causes the raising or lowering of the platform.

In some embodiments, the system 10 may be configured so that the rotation of the platform 20 has a maximum speed at which an able-bodied person may safely (i) enter the platform 20 through the first access point 21 and exit the platform through the second access point 22 and (ii) enter the platform through the second access 22 point and exit the platform through the first access point 21 while the platform is spinning. In other embodiments, the system 10 may be configured so that an able-bodied person may (i) enter the platform 20 through the first access point 21 and exit the platform through the second access point 22 and (ii) enter the platform through the second access 22 point and exit the platform through the first access point 21 only when the platform is not spinning or only when the platform is spinning at a speed at which such movement is safe.

FIG. 5A shows an embodiment in which the platform 20 is cantilevered from a hoist tower 44. However, in some embodiments, such as where a very large diameter platform is desired, alternative arrangements may be more suitable. FIGS. 5B and 5C show some alternative embodiments. In FIG. 5B, for instance, a large diameter platform 20 is built around a hoist tower 44, with the hoist tower extending through the middle of the platform. In FIG. 5C, a large diameter platform 20 is cantilevered from two hoist towers 44, which are located on opposing sides (or quadrants) of the platform. The selection of a particular arrangement is largely viewed to be a design choice and should have little effect on the operation of the system 10 as described herein.

It can be seen that the described embodiments provide a unique and novel system 10 that has a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A system for lifting one or more persons onto a play structure, comprising:
a platform having at least a first access point and a second access point;
a first landing and a second landing,
the first landing being positioned at a first level and the second landing being positioned at a second level, the second level being vertically displaced from the first level, and
the first landing being adjacent to the first access point of the platform and the second landing being adjacent to the second access point of the platform; and
a lifting system configured to (a) raise the platform vertically from the first level to the second level and (b) lower the platform vertically from the second level to the first level;
wherein the system is configured so that a person may
(i) enter the platform through the first access point and exit the platform through the second access point, and
(ii) enter the platform through the second access point and exit the platform through the first access point
while the platform is being raised or lowered.

2. The system of claim 1, wherein at least the second landing is associated with a component of a playground structure.

3. The system of claim 1, wherein the platform is configured to accommodate at least one wheelchair.

4. The system of claim 1, wherein the first and second access points are on opposing sides of the platform.

5. The system of claim 1, wherein the second level is between about 24 inches and about 36 inches above the first level.

6. The system of claim 5, wherein the second level is about 30 inches above the first level.

7. The system of claim 1, wherein the lifting system comprises a chain hoist.

8. The system of claim 7, wherein the chain hoist is operated by one or more hand cranks.

9. The system of claim 8, wherein at least one of the hand cranks is located at the first landing or the second landing.

10. The system of claim 9, wherein a first hand crank is located at the first landing and a second hand crank is located at the second landing.

11. The system of claim 1, wherein the lifting system comprises a motorized hoist.

12. The system of claim 1, further comprising a first safety gate and a second safety gate, the first safety gate being configured to prevent a wheelchair from accessing or exiting the platform through the first access point unless the platform is at the first level and the second safety gate being configured to prevent a wheelchair from accessing or exiting the platform through the second access point unless the platform is at the second level.

13. The system of claim 12, wherein the raising and lowering of the platform is configured to actuate the opening and closing of each of the first and second safety gates.

14. The system of claim 1, further comprising a protective shield positioned below the platform and configured to prevent persons and objects from entering the space below the platform.

15. The system of claim 1, further comprising
a protective cover positioned between the edge of the first landing and the platform and configured to prevent persons and objects from being pinched between the platform and the first landing, and
a protective cover positioned between the edge of the second landing and the platform and configured to prevent persons and objects from being pinched between the platform and the second landing.

16. The system of claim 1, wherein the platform is configured to rotate.

17. The system of claim 16, wherein the raising or lowering of the platform causes the platform to rotate.

18. The system of claim 16, wherein the platform is configured to be manually rotated by one or more users located on the platform.

19. A play structure comprising at least one lifting station, the lifting station comprising the system of claim 1.

20. A play structure comprising at least a first lifting station and a second lifting station, each of the first and second lifting stations comprising the system of claim 1, and the first and second lifting stations being connected in series.

21. The play structure of claim 20, in which the second landing of the first lifting station also serves as the first landing of the second lifting station.
